(19) United States
(12) Patent Application Publication
(10) Pub. No.: US 2005/0081931 A1
(43) Pub. Date: Apr. 21, 2005

(54) Connecting device for fluids

(76) Inventors: Ranko Dezso, Budapest (HU); Jozsef Istvan, Budapest (HU)

Correspondence Address: Charles R Hoffmann;Hoffmann & Baron, 6900 Jericho Turnpike, Syosset, NY, 11791, US

(21) Appl. No.: 10/018,639

(22) PCT Filed: Apr. 27, 2001
(86) PCT No.: PCT/EP01/04776

(30) Foreign Application Priority Data
May 3, 2000 (DE) 20007980.8

(51) Int. Cl. F17D 1/00

(52) U.S. Cl. 137/884

(57) ABSTRACT

A connection means for two base bodies (3a and 3b) of a subassembly conducting a fluid. On each base body (3a and 3b) holding means are provided, which respectively have at least one holding pin (16) projecting toward the respectively other base body (3a and 3b), such holding pin fitting between two coupling bodies (17 and 18) and being at the same time peripherally acted upon by the working faces (22 and 23) of both coupling bodies (17 and 18). The coupling bodies (17 and 18) are able to be clamped together athwart the connection direction (5) of the two base bodies (3a and 3b) and by virtue of oblique faces are able to exert a connection force (Fᵥ) acting to produce a movement together of the base bodies (3a and 3b).

The invention relates to a connection means for two base bodies of a fluid conducting subassembly and more particularly to a modularly designed device for treating compressed air, comprising holding means provided on the mutually facing connection faces of the base bodies to be connected, and furthermore a coupling unit fitting between the base bodies to be connected, said coupling unit having two coupling bodies, said coupling bodies being able to be clamped athwart the connection direction of the two base bodies and thereby by virtue of inclined faces extending obliquely in relation to the connection direction exerting a connection force on the holding means, said connection force acting to provide a movement together of the base bodies.

Such a connection means is for instance described in the patent publication WO 95/02149 in connection with a device for treating compressed air. The latter comprises a plurality of components, whose housing-like base bodies are connected together firmly and at the same time in a fluid-tight fashion with a coupling unit between them. The coupling unit comprises a slide-like first coupling body able to be introduced between the two base bodies, said first coupling body being clamped against a second coupling body mounted from the opposite side, so that inclined working faces provided on the coupling bodies cooperate with correspondingly inclined oblique faces on the base bodies and acting on the inclined plane principle ensure that the base bodies are clamped together. The oblique faces of the base bodies are provided on holding means, which are formed by integral marginal extensions of the base bodies.

In the case of a similar connection means disclosed in the U.S. Pat. No. 5,372,392 after the putting base the bodies together clamp-like coupling bodies are applied from the outside. In order to create a pressure-tight connection a separate perforated intermediate plate is inserted between the base bodies to be connected.

Unlike this known design the German patent publication 19,707,630 C1 discloses a connection means, in the case of which the base bodies are in direct contact at their connection faces, coupling bodies, which are clamped together, being mounted on the side faces of the base bodies.

One object of the present invention is to provide a connection means of the type initially mentioned rendering possible easy handling and a reliable connection of two base bodies.

On the basis of a connection means of the type initially mentioned this object is to be achieved by the invention because the holding means provided on each respective base body each possess at least one holding pin extending toward the other base body, said pin fitting between the two coupling bodies and simultaneously being acted upon peripherally by the working faces of both coupling bodies.

It is in this manner that the connection force clamping the base bodies held together may be caused to act at the relevant points in order to systematically clamp the base bodies together at those positions which are best from the point of view of design and function. There is for instance the possibility of so applying the connection forces that in the peripheral part of communicating fluid ducts of the base bodies there is an optimum sealing pressure. On the contrary in the prior art the application of the forces necessarily takes place at the edge of the base bodies, something which can not always ensure the desired area related pressure. Furthermore, the connection means may be manufactured extremely simply and it is extremely easy to use.

Further advantageous developments of the invention are defined in the dependent claims.

It would in principle be possible, for the connection of the coupling unit with a respective base body, to provide only one holding pin. However, for reasons of symmetry and optimum application of force, recourse will generally be had to a plurality of holding pins for each base body, it being best more particularly to have two spaced holding pins in each case, which again may cooperate with working faces of both coupling bodies simultaneously.

If the connection means is at the same time to provide a fluid-tight between fluid ducts in the two base bodies, it is an advantage for the two holding pins to be arranged on the associated connection faces on diametrally opposite sides of the respective duct opening.

The two holding pins are preferably located respectively within the periphery of the connection face in contact with the coupling unit, of the associated base body, while at the same time being more particularly placed near the edge of the respective connection face render possible a large flow cross section for the fluid ducts to be connected.

For the sake of improving even application of the connection force it is furthermore an advantage for the holding pins of the base bodies to be joined to be coaxially opposite each other in pairs. If screw connection means are provided for mutually clamping the two coupling bodies together, which have clamping screws acting on the two couple bodies, the arrangement will preferably be such that respectively one of the clamping screws extends through the axial intermediate space between the two associated paired holding pins. Accordingly the forces applied by the clamping screws are directed along the shortest path and applied to the holding pins.

When the coupling bodies are clamped the working faces provided on them will cooperate with the mating working faces provided on the holding pins. Although respectively merely one of such types of faces can have an inclined form, it is an advantage if in both cases the design is in the form of oblique faces, whose angle of inclination is preferably identical in relation to the connection means so that they extend in parallelism to one another. Dependent on the particular design the oblique faces can be straight or curved in shape.

The holding pins may in some cases be an integral part of the associated base body, but however for reasons of convenience of manufacture it is preferred to have a separate design for firmly fixing to the associated base body. For anchoring it is more particularly possible to use a screw connection, the holding pins being able to have a threaded shank by means of which they are firmly screwed in the associated base body.

It is furthermore an advantage for the mating working faces of the holding pins to be respectively provided on a peripheral radial projection on the respective holding pin, which may be constituted by a head of the holding pin. The mating working face then will preferably have a conical shape becoming narrower toward the associated connection face.

When the connection has been produced the coupling bodies are preferably clamped together and also respectively braced against the holding pins and furthermore with the connection faces of the base bodies. For this purpose it is possible for each holding pin to possess a mating working face facing the connection face of the base body bearing it and cooperating with the associated faces of the coupling bodies, the coupling bodies fitting between a respective mating working face and the connection face facing same and acting on both the mating working face and also the connection face. It is convenient for the coupling bodies to engage each other in the clamped condition so that a fixed abutment is formed.

If a fluid connection is to be produced through the coupling unit between fluid ducts in the two base bodies, it is advantageous for a corresponding through duct of the coupling unit to be formed completely in only one of the two coupling bodies so that between the two coupling bodies no sealing means are necessary. In order nevertheless to have compact dimensions of the coupling unit, the through duct may be delimited at the side facing the other coupling body by an outwardly curved wall fitting into a complementary recess in the other coupling body.

In what follows the invention will be described with reference to the accompanying drawings.

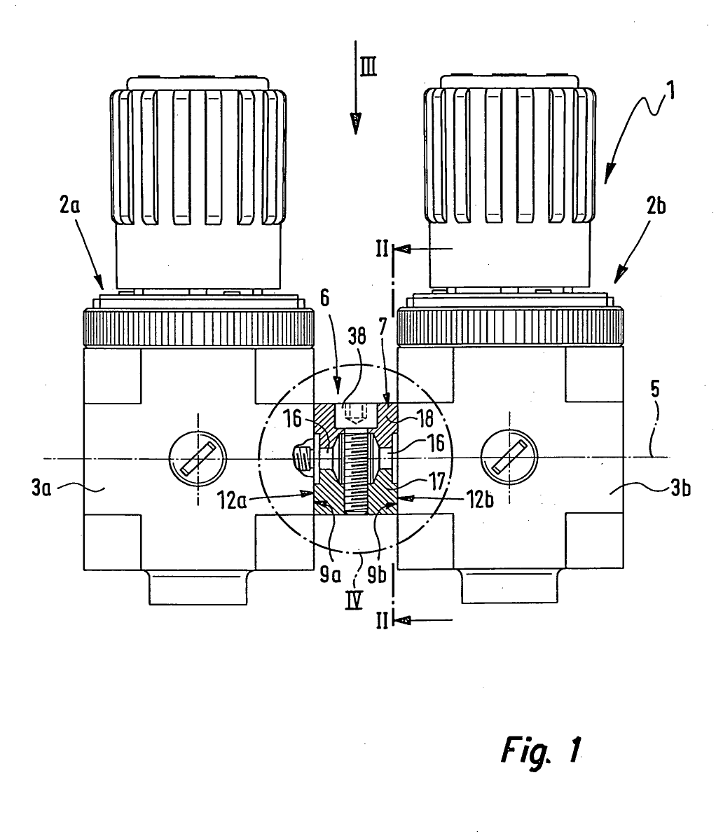

FIG. 1 shows a device for treating compressed air in the form of a subassembly and having two functional units, which are connected firmly or permanently together by the intermediary of a preferred embodiment of the connection means of the invention.

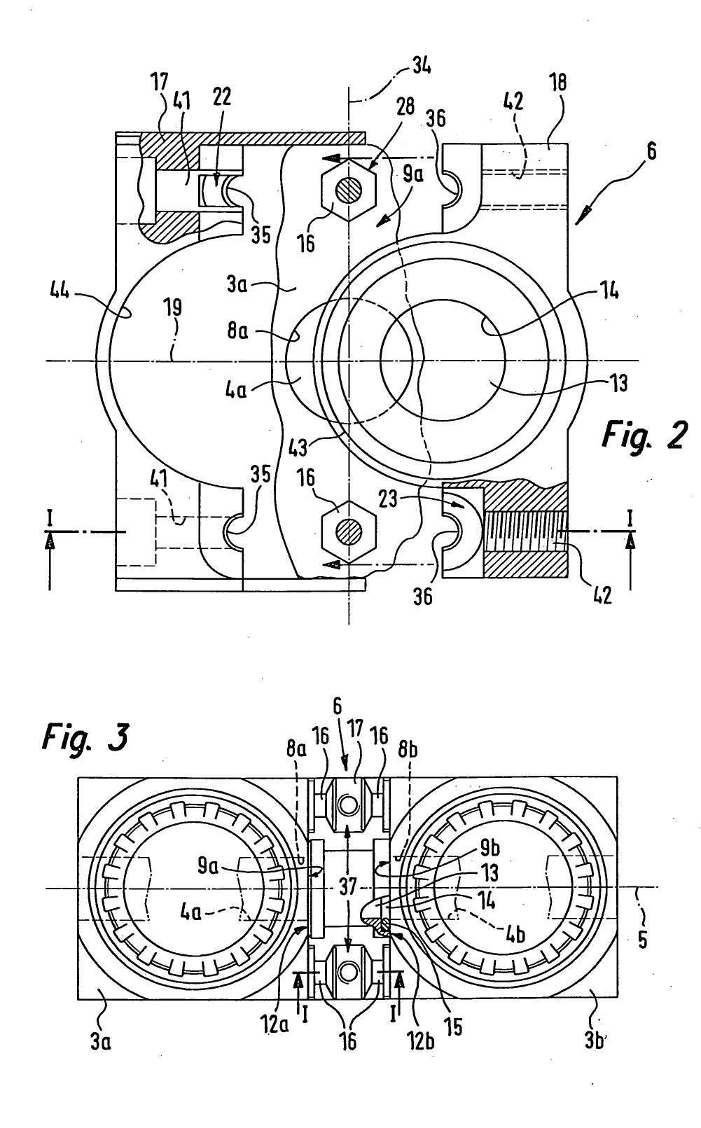

FIG. 2 shows part of the arrangement of FIG. 1 as sectioned on the line II - II, the coupling unit being illustrated during mounting on the two base bodies of the functional units while the coupling units are still separate from each other.

FIG. 3 is a plan view of the arrangement of FIG. 1 looking in the direction of the arrow III, the coupling unit being depicted with the top coupling body removed.

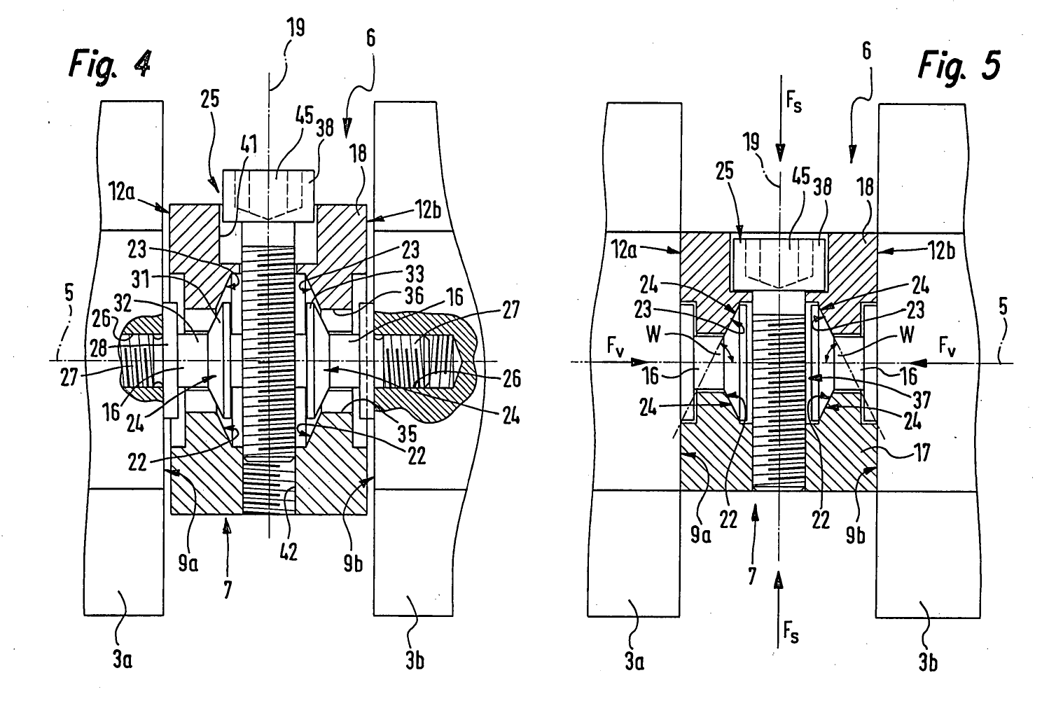

FIG. 4 shows the part marked IV on a larger scale with the as yet not completely mounted, unclamped coupling unit.

FIG. 5 is a view similar to that of FIG. 4 with the coupling unit completely mounted and clamped.

By way of example FIG. 1 shows a device 1 serving for the conditioning or treatment of compressed air, such device being in the operational state placed on a compressed air line, not illustrated in detail. The device 1 could also be termed a compressed air servicing device. It is a modular subassembly through which a fluid flows during operation and which in the working example comprises two diagrammatically indicated functional units 2a and 2b which could for example be a pressure regulating unit, a filter unit and/or an oiler unit.

The individual functional units each comprise a body which in the example here is a block- or cube-like in shape, and which will as a rule be like a housing in structure and in the present case are referred to as base bodies 2a and 2b.

Each of the base bodies 3a and 3b respectively comprises at least one internal fluid duct 4a and 4b, which is indicated in chained lines in FIG. 3 respectively opening at opposite end faces of the respective base body 3a and 3b. The base bodies 3a and 3b may be arranged in any desired number along a connection direction 5 indicated in chained lines, immediately following base bodies being able to be detachably connected together using the connection means 6 in accordance with the invention. In the present case the fluid ducts 4a and 4b of adjacent base bodies 3a and 3b are also connected together so that a common flow duct is produced extending through the entire device 1, such duct communicating with the connectable fluid ducts. Within each functional unit 2a and 2b the respective section of the fluid duct 4a and 4b constituting the corresponding section of the flow duct will have a form specific to its function and may for instance act so that the fluid pressure medium is passed through a filter means or a pressure regulating unit.

The connection means 6 comprises a coupling unit 7, which is placed and fits,between the base bodies 3a and 3b to be connected. In the mounted state the base bodies 3a and 3b have their facing connection faces 9a and 9b in engagement with a respectively facing coupling face 12a and 12b of the intermediately placed coupling unit 7. The connection faces 9a and 9b are provided here on those side faces of the base bodies 3a and 3b, at which a duct opening 8a and 8b of the associated fluid duct 4a and 4b is located. The coupling faces 12a and 12b are located on mutually opposite sides of the coupling unit 7.

By the intermediary of the connection means 6 the base bodies 3a and 3b may be detachably clamped together to form a component group, able to be handled as a single body with the coupling unit 7 in between.

The coupling unit 7 possesses a through duct 12, which preferably extends through the coupling unit 7 in the direction 5 of connection and opens at both coupling faces 12a and 12b. Its openings 14 are in this case flush with the respectively associated duct opening 8a and 8b, there being in the joint between the coupling unit 7 and a respective base body 3a and 3b an intermediately fitted annular seal 15, which is concentric to the above mentioned openings, such seal 15 providing for a transfer passage, sealed off from the outside, between the fluid ducts 4a and 4b and the through duct 13. The annular seal 15 will as a rule consist of elastically resilient material and is axially clamped between on the one hand the connection faces 9a and 9b on the other hand the coupling faces 12a and 12b.

In addition to the coupling unit 7 the connection means 6 comprises holding means, arranged on the base bodies 3 to be connected, in the form of separate holding pins 16, which are located on the connection faces 9a and 9b, same being preferably placed within the periphery, which in the working example is rectangular, of the respectively associated connection face 9a and 9b. In relation to two base bodies 3a and 3b to be connected together there is a provision such that each base body 3a and 3b has at least one holding pin 16 on the connection face 9a and 9b facing the other base body 3a and 3b, such pin extending like projection past the associated connection face 9a and 9b and extending away from same toward the oppositely placed connection face of the other base body.

The holding pins 16 cooperate with the coupling unit 7, which, which possesses two first and second coupling bodies 17 and 18 to be clamped or braced together athwart the connection direction 5. The direction 19 of clamping is indicated in the drawings by a chained line. Such line runs in parallelism to the plane of the coupling faces 12a and 12b, which are also mutually parallel and thus at a right angle to the connection direction 5.

The holding pins 16 fit between the two coupling bodies 17 and 18, such pins peripherally respectively having a mating working face 24, which at the same time is able to be acted upon by the first and the second working faces 22 and 23 of the two coupling bodies 17 and 18. Either both working faces 22 and 23 or the mating working face 24, but preferably both working faces 22 and 23 and also the mating working face 24—this being the case with the embodiment illustrated—are oblique faces and inclined in relation to the connection direction 5, the angle of inclination being indicated in the figure as “w”. Here the angle of inclination of the working faces 22 and 23 and of the mating working face 24 is preferably identical.

As shown in FIGS. 4 and 5, the mating working face 24 is arranged some distance in front of the base bodies 3a and 3b bearing the respective holding pin 16, while at the same time facing the above mentioned connection line. The working faces 22 and 23 are on the contrary so arranged on the two coupling faces 17 and 18 that they face away from that connection face 9a and 9b, which has the holding pin 16, with which they individually cooperate. In this respect both the working faces 22 and 23 and also mating working face 24 extend, with an increasing distance form the connection face 9a and 9b, obliquely athwart the connection direction 5 in an outward direction.

In order to ensure a firm connection between the base bodies 3a and 3b the two coupling bodies 17 and 18 (which are preferably in the form of separate components) are introduced from opposite sides in the clamping direction between the base bodies 3a and 3b and mounted on the holding pins 16. This phase is illustrated in FIGS. 2 and 4. Following this the two coupling bodies 17 and 18 are braced together by tightening or loading means 25 in the clamping direction 19 toward one another and clamped together with a clamping force Fₛ firmly, the first and the second working faces 22 and 23 coming into engagement with the mating working face 24 of the holding pins 16 and acting on same. During this clamping or bracing operation by means of the working faces and mating working faces, sliding on each other the mutually facing coupling faces 12a and 12b and the connection faces 9a and 9b are simultaneously moved together and urged onto one another. All in all this inclined plane action means that from a connection force Fₛ, applied in the connection direction 19, a connection force Fᵥ—effective in the connection direction 5—and by such connection force Fᵥ the base bodies 3a and 3b, firmly connected with the holding pins 16, are drawn and braced firmly together with the coupling unit 7 in between.

In the working embodiment the mating working faces 24 possess a conical configuration. Accordingly it is possible for the first and the second working faces 22 and 23 to be respectively constituted by a peripheral section of a conical face possessing a suitable cone angle. In principle a flat oblique face would also be possible.

Generally it is to be pointed out that the oblique faces do not necessarily have to have a straight form and it may be a question of curved or vault-like faces.

The holding pins 16 could possibly be in the form of integral components of the base bodies 3a and 3b, but it is preferred to adopt the structure employed in the working example in the form of separate components, which are attached or anchored to the respective base body 3a and 3b by suitable means. More particularly, a detachable anchoring means may be provided for, each base body 3a and 3b having suitable attachment means 26 at mutually opposite connection faces, such means 26 allowing customized anchoring of a holding pin 16. This means that it is possible for the base bodies 3a and 3b to be fitted, if required, with holding pins 16 on those side faces, at which connection with an other base body is to take place.

In the working embodiment illustrated the holding pins 16 are screwed to the associated base body 3a and 3b. For this purpose it is possible for the attachment means 26, as illustrated, to be in the form of threaded holes in the base bodies 3a and 3b at the connection faces 9a and 9b, into which holes a threaded shank 27 of the holding pins may be screwed. The holding pins 16 are accordingly special-purpose or customized screws and preferably have a specially formed tool engaging portion 28—for instance a polygonal portion—for engagement with a wrench.

The mating working face 24 is preferably located on a radial projection 31 like a sort of surrounding annular collar, which by means of a shank-like intermediate portion 32—preferably with the tool engagement portion 28 in between—is connected with the screw shank 27 and projects beyond shank-like intermediate portion 32 radially. Preferably, it is possible for the radial projection 31, as illustrated, to be constituted by a head section 33 of the respective holding pin 16.

As clearly shown in FIGS. 2 and 3, in each case several and preferably two holding pins 16 are arranged on the two connection faces 9a and 9b, such holding pins being at a distance apart from each other. As regards the central duct opening 8a and 8b it is more particularly possible to make a provision such that the two holding pins 16 are located on diametrally opposite sides of the associated duct opening 8a and 8b, the latter thus being flanked on diametrally opposite sides by same. The centers of each respective duct opening 8a and 8b and of the holding pins 16 flanking same in this case preferably lie on a common imagery connection line 34, which runs at a right angle to the clamping direction 19.

The coupling bodies 17 and 18, which are braced together, fit around the holding pins 16 preferably like cleats or curved clips, each of the coupling bodies having a recess 35 and 36 and a first and a second working face 22 and 23 for each holding pin 16 to partly receive same. Accordingly in the working example each coupling body 17 and 18 has four working faces 22 and 23 with associated recesses 35 and 36, preferably completely surrounding the respective holding pin 16 in the state in which the parts are clamped together.

Because the holding pins 16 are placed within the periphery of the connection faces 9a and 9b, they may be placed as close as possible to the duct transition between the through duct 13 and the fluid ducts 4a and 4b so that the resulting connection forces Fᵥ take effect in the immediate vicinity of the seals 15 and a reliable seal specific surface pressure is established. However, the holding pins 16 may be placed near the edge of the respective connection face in order to render possible large flow cross sections of the through duct 13 and of the fluid ducts 4a and 4b. Owing to the use of holding pins it is furthermore possible for extremely compact transverse dimensions to be designed for.

The holding pins 16 on the connection faces 9a and 9b on either side are preferably so arranged that same coaxially opposite each other in pairs. Each holding pin 16 of the one base body 3a is therefore in line in the connection direction 5 with a holding pin 16 on the other base body 3b. This ensures a symmetrical application of forces is such that the holding pins 16 of each aligned holding pin pair do not engage each other even when coupling bodies 17 and 18 are clamped so that the clamping operation is not interfered with. On the contrary, it is even an advantage for the width, as measured in the connection direction 5, of the two coupling bodies 17 and 18 to be so set in relation to the length of the holding pins 16 that in the clamped state as well an intermediate space 27 will remain between the respectively mutually aligned holding pins 16, it being possible for clamping means to extend through the space 27.

These clamping means 25 are constituted by screw connection means in the working embodiment, a clamping screw 38 being associated with pair of holding pins in alignment with each other, such screw 38 clamping together the two coupling bodies 17 and 18 and extending respectively through one of the intermediate spaces 37. This means that the lines of introduction or application of the connection force Fᵥ and of the clamping force Fₛ may be in the direct vicinity of each other and preferably, as in the example, even intersect, something which ensures an optimum redirection of forces without the danger of action on the skew.

In the working embodiment illustrated there is a provision such that for the placement of a respective clamping screw 38 the one coupling body 18 possesses a through hole 41, which is in line with a threaded hole 42 in the other coupling body 17 so that the clamping screw 38 can be screwed into the threaded hole 42 after slipping it through the hole 41, such screw coming at its head 45 into engagement with the coupling body 18 having the through hole 41. The head 45 preferably fits into a counter-sunk recess at the end of the through hole 41.

As shown clearly in FIG. 5 the two coupling bodies 17 and 18 are preferably so designed that in the braced together state they fit between a respective mating working face 24 and the connection face 9a and 9b facing same. There is here a provision such that the coupling bodies 17 and 18 engage each other in the clamped state so that it is possible to achieve a limitation of the end connection force Fᵥ in order to forestall danger owing to overloads.

As shown in FIG. 2 the through duct 13 preferably extends in only one of the coupling bodies, in the present case this being the second coupling body 18. This means that there is an uninterrupted, continuous duct wall surrounding and defining the through duct 13 and it is possible to do without seal means between the braced together coupling bodies 17 and 18.

In order nevertheless to have a through duct 13 with maximum flow cross section, the through duct 13 is delimited at the side facing the first coupling body 17 by an outwardly bulging wall 43 in the second coupling body 18, which fits into a complementary recess in the first coupling body 17, which in this case may have an essentially U-like configuration. Thus it is possible to ensure extremely compact transverse dimensions of the coupling unit 7 when the coupling bodies 17 and 18 are fitted together.

When the coupling unit 7 is mounted the joint zone, defined between the two coupling bodies 17 and 18 extends in the outer portion, associated with the holding pins 16, generally along the imaginary connection line 34 in order to depart from the said connection line 34 between the holding pins 16 in the direction 19 of clamping, for example along an arc around the through duct 13.

It is furthermore to be noted that the connection means may also be employed for joining together bodies of other subassemblies besides devices serving for the treatment of compressed air, as for example valve bodies or module bodies in fluid distributing plates.

1. A connection means for two base bodies of a fluid conducting subassembly and more particularly a modularly designed device for treating compressed air, comprising holding means provided on the mutually facing connection faces (9a and 9b) of the base bodies (3a and 3b) to be connected, and furthermore a coupling unit (7) fitting between the base bodies to be connected, said coupling unit (7) having two coupling bodies (17 and 18), said coupling bodies (17 and 18) being able to be clamped athwart the connection direction (5) of the two base bodies (3a and 3b) and thereby by virtue of inclined faces extending obliquely in relation to the connection direction (5) exerting a connection force (Fᵥ) on the holding means, said connection force acting to provide a movement together of the base bodies (3a and 3b), characterized in that the holding means provided on each respective base body (3a and 3b) each possess at least one holding pin (16) extending toward the respectively other base body (3a and 3b), said pin fitting between the two coupling bodies (17 and 18) and simultaneously being acted upon peripherally by working faces (22 and 23) of both coupling bodies (17 and 18).

2. The connection means as set forth in claim 1, characterized in that on the connection faces (9a and 9b) of both base bodies (3a and 3b) respectively two mutually spaced apart holding pins (16) are provided, which respectively are able to cooperate with working faces (22 and 23) of both coupling bodies (17 and 18).

3. The connection means as set forth in claim 2, characterized in that the two holding pins (16) on the associated connection face (9a and 9b) are arranged on mutually diametrally opposite sides of the opening (8a and 8b) of a fluid duct (4a and 4b) opening toward the connection face (9a and 9b).

4. The connection means as set forth in any one of the claims 1 through 3, characterized in that the holding pins (16) are placed within periphery of the associated connection face (9a and 9b) in contact with the coupling unit (7), such holding pins being located preferably near the edge of the respective connection face (9a and 9b).

5. The connection means as set forth in any one of the claims 1 through 4, characterized in that the holding pins (16) are in the form of components separate from the associated base body (3a and 3b), which components are attached to the respective base body (3a and 3b) more particularly in a detachable manner.

6. The connection means as set forth in claim 5, characterized in that the holding pins (16) are screwed to the associated base body (3a and 3b).

7. The connection means as set forth in any one of the claims 1 through 6, characterized in that the holding pins (16) on the base bodies (3a and 3b) to be connected together are coaxially opposite to one another in pairs.

8. The connection means as set forth in any one of the claim 1 through 7, characterized in that for the mutual clamping together of the two coupling bodies (17 and 18) clamping means (25) engaging same are provided which are preferably in the form of clamping means (25) designed in the form of screw connection means.

9. The connection means as set forth in claim 8 in conjunction with claim 7, characterized in that the clamping means (25) are provided with clamping screws (38) one respective clamping screw fitting through an intermediate space (37) present between two holding pins (16) associated with each other in a pair.

10. The connection means as set forth in any one of the claims 1 through 9, characterized in that both the working faces (22 and 23) of the coupling bodies (17 and 18) and also the mating working faces (24) cooperating with the same, of the holding pins (16) are designed in the form of oblique faces.

11. The connection means as set forth in claim 10, characterized in that, as related to the connection direction (5) of the two base bodies (3a and 3b), the working faces (22 and 23), have the same angles (w) of inclination as the mating working faces (24).

12. The connection means as set forth in any one of the claims 1 through 11, characterized in that the mating working faces (22 and 23,) cooperating with the working faces (22 and 23), of the holding pins (16) have a conical form.

13. The connection means as set forth in any one of the claims 1 through 11, characterized in that the mating working faces (22 and 23,) cooperating with the working faces (22 and 23), of the holding pins (16) are provided on a surrounding radial projection (31), which preferably is formed by a head portion (33) of the respective holding pin (16).

14. The connection means as set forth in any one of the claims 1 through 13, characterized in that each holding pin (16) possesses a mating working face (24) facing the connection face (9a and 9b) of the base body (3a and 3b) bearing it and cooperating with the associated working faces (22 and 23) of the coupling bodies (17 and 18), the coupling bodies (17 and 18) fitting, in the clamped together condition thereof, between a respective mating working face (24) and the associated connection face (9a and 9b) and acting on both the mating working face (24) and the connection face (9a and 9b).

15. The connection means as set forth in any one of the claims 1 through 14, characterized in that the coupling bodies (17 and 18) fit round the holding pins (16) like clips in the clamped together state, each coupling body (17 and 18) possessing, for each holding pin (16), a recess partly receiving it.

16. The connection means as set forth in any one of the claim 1 through 15, characterized in that the coupling bodies (17 and 18) engage each other in the direction of the biasing force when in the clamped together state.

17. The connection means as set forth in any one of the claims 1 through 16, characterized in that the coupling unit (7) has a through duct (13) flush with the duct openings (8a and 8b) provided on the connection faces (9a and 9b) in the fitted state, such through duct being completely formed in one of the two coupling bodies.

18. The connection means as set forth in claim 17, characterized in that the through duct (13) provided on the one coupling body (18) is delimited, on the side facing the other body (17), by a wall bulging out toward the other coupling body (17), such wall fitting into a complementary recess in the other coupling body (17).

19. The connection means as set forth in claim 17 or in claim 18, characterized in that an annular seal (15) is fitted between the coupling body (18) having the opening and the two base bodies (3a and 3b) to be connected, said seal being coaxial in relation to the through duct (13).
